(19) United States
(12) Patent Application Publication
(10) Pub. No.: US 2008/0197949 A1
(43) Pub. Date: Aug. 21, 2008

(54) Actuator Assembly, Method of Driving an Actuator Assembly and Apparatus for Driving an Actuator Assembly

(75) Inventors: Johan Francis Lurquin, Eindhoven (NL); Robby Francis Maes, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/994,461

(22) PCT Filed: Jun. 30, 2006
(86) PCT No.: PCT/IB2006/052210

§ 371 Date: Jan. 2, 2008

(30) Foreign Application Priority Data
Jul. 7, 2005 (EP) 05106205.7
Mar. 23, 2006 (EP) 06111619.0

(51) Int. Cl. H01F 7/08; H01H 47/00

(52) U.S. Cl. 335/229; 361/160

(57) ABSTRACT

An actuator assembly includes a first part (2), a second part (3), the second part (3) including a guide (5,6) for guiding motion of the first part (2) relative to the second part (3), and means (10,11; 16-18; 20-22; 24-27) for generating a driving force between the first part (2) and the second part (3) along the guide(s) (5,6) in response to a driving current. The actuator assembly includes means (5,6,10; 16,18; 21,22; 24,25,27) for providing a force transverse to the guide (5,6), acting to hold at least one surface part of the first part against a surface of the guide (5,6).

The invention relates to an actuator assembly, including a first part, a second part, the second part including at least one guide for guiding motion of the first part relative to the second part, and means for generating a driving force between the first part and the second part along the guide(s) in response to a driving current.

The invention also relates to a method of driving an actuator assembly, which actuator assembly includes a first part, a second part, the first part being movable relative to the second part, and means for generating a driving force between the first part and the second part in response to a driving current, wherein the first part is displaced in opposition to a substantially constant frictional force from a first position to a second position.

The invention also relates to an apparatus for driving an actuator assembly, which actuator assembly includes a first part, a second part, the first part being movable relative to the second part, and means for generating a driving force between the first part and the second part in response to a driving current, wherein the first part is displaced in opposition to a substantially constant frictional force from a first position to a second position, which apparatus comprises an apparatus for applying a driving current to the means for generating a driving force.

The invention also relates to an opto-mechanical device comprising an actuator assembly.

Respective examples of such an assembly, method, apparatus and device are known. US-A1-2004/0234258 discloses a lens driving device and imaging device. A driven body has an optical lens, a sleeve on one side and a slot on the opposite side, so as to sandwich a light axis together with the sleeve. Further, a guide shaft is a shaft fitting into the sleeve in order to cause the driven body to move along the direction of the optical axis. The guide shaft is a shaft inserted as a brace at the slot and is for preventing the driven body from rotating taking the guide shaft as a center. A flat coil is fixed to the driven body. The position of the driven body is detected by a position detection magnet fitted to the driven body and a magnetoresistive element arranged in a non-contact manner spaced from the magnet. When current flows in the drive coil, thrust parallel with the optical axis direction is generated. Frictional resistance generated between the driven body and the guide shafts becomes fixed because the thrust direction and drive direction are always parallel over the entire region of the drive stroke. Drive characteristics and servo characteristics can be made superior.

A disadvantage of the known assembly and known method is that the servo control to keep the driven body positioned constantly consumes power and makes the lens drive relatively complicated. The known assembly requires the servo control to correct for displacements due to external influences.

It is an object of the invention to provide an assembly, method, apparatus and device of the types defined in the opening paragraphs that allow for relatively simple and efficient positioning of the first part relative to the second part of the actuator assembly.

This object is achieved by means of the actuator assembly according to the invention, which is characterized in that the actuator assembly includes means for providing a force transverse to the guide, acting to hold at least one surface part of the first part against a surface of the guide.

The actuator assembly includes means for generating a driving force in response to a driving current, in order to displace the first part with respect to the second part. Because the actuator assembly according to the invention further includes means for providing a force transverse to the guide, acting to hold at least one surface part of the first part against a surface of the guide, a substantially constant dynamic frictional force, opposing the driving force, is present when the first part is moved along the guide. Since the resistance encountered by the first part is well defined, it is even possible to use open-loop control to position the first part relative to the second part. This is more efficient and simpler than servo control. In the absence of a driving current, the force transverse to the guide ensures that a static frictional force is maintained, which prevents displacement due to external influences. An additional advantage of the assembly is that the area of contact between the first and second part remains substantially constant even in the face of wear, due to the force holding them against each other.

In an embodiment of the actuator assembly, the means for providing a force transverse to the guide include at least one means for establishing a field of force, attached to one of the first and second parts and acting on at least a component of the other of the first and second parts.

Because of the action at a distance, i.e. forces experienced by an electric charge, magnet or mass at a distance from an independent electric charge, magnet or mass, the first part is less constrained in its movement relative to the second part. In particular, it can move over a relatively large distance.

In an embodiment of the actuator assembly, the means for providing a force transverse to the guide include at least one permanent magnet, attached to one of the first and second parts.

Due to the presence of the permanent magnet, separate energizing of the means for providing the force transverse to the guide is not required. This enhances the energy-efficiency of the actuator assembly.

In a variant of this embodiment, the means for generating a driving force include at least one electrically conductive coil, attached to the other of the first and second parts, for generating a magnetic field acting on the at least one permanent magnet, in response to the driving current.

This variant is simpler in construction, since the permanent magnet or magnets are comprised in both the means for generating a driving force and the means for providing the force transverse to the guide.

In a further variant, the other of the first and second parts includes a ferromagnetic back plate, wherein the electrically conductive coil is positioned between the ferromagnetic back plate and at least one of the permanent magnets.

This has the advantage of amplifying the magnetic field created by the electrically conductive coil. The energy efficiency is thus further improved. The permanent magnet may be made smaller, decreasing the mass of the part to which it is attached.

In another variant, the second part includes a ferromagnetic back plate, wherein one of the electrically conductive coil and the at least one permanent magnet is positioned between the ferromagnetic back plate and the other of the electrically conductive coil and the at least one permanent magnet.

Thus, the mass of the first part can be kept low, because the second part includes the guide and the ferromagnetic back plate enhances the magnetic field. In one implementation, the electrically conductive coil is attached to the first part, whereas in another implementation the permanent magnet or magnets is/are attached to the first part. In one implementation, the first part experiences a relatively strong magnetic field. This gives fast response times in combination with the relatively low mass. In another implementation, the energy consumption is reduced, which is made possible by the amplification of the magnetic field that is due to the ferromagnetic back plate.

In a further variant, the at least one permanent magnet includes two magnetized zones, positioned in a line, wherein respective components of magnetization perpendicular to the line are oriented in opposite directions.

The effect is that a magnetic field for generating the driving force along the guide and a magnetic field for generating the force transverse to the guide can be provided by means of a single component. In particular, the need to provide a yoke for guiding the magnetic flux is largely removed. This reduces the mass of the part of the actuator assembly to which the permanent magnet is attached.

According to another aspect, the method of driving an actuator assembly according to the invention is characterized by applying a pulsed driving current to the means for generating a driving force, pre-determined to result in a total displacement substantially equal to the distance between the first and the second position.

The displacement may be effected by applying a current comprising only one pulse. By applying a pulsed driving current, pre-determined to result in a desired total displacement, the means for generating a driving force are energized for shorter periods of time, resulting in lower energy consumption. Because the first part is displaced relative to the second part in opposition to a substantially constant frictional force, it is possible to apply reasonably accurate open loop control of the position. The two forces acting on the first part are relatively well defined.

In an embodiment, the pulsed driving current has a waveform in the shape of a periodic pulse train, wherein each period includes a first interval during at least part of which a current is applied, followed by a second interval during which the magnitude of any current applied is lower than a current level for generating a driving force sufficient to overcome the substantially constant frictional force, wherein the length of the second interval equals at least the integral of a net force resulting from the generated driving force and the substantially constant frictional force over the first interval divided by the magnitude of the substantially constant frictional force.

Thus, each displacement can be effected as a series of substantially equal incremental displacements. It is not necessary to store a function or table relating driving currents and/or pulse durations to each possible displacement distance. Instead, a desired displacement can be broken down into a succession of incremental displacements, each accomplished during one period of the pulse train. Because the length of the second interval equals at least the integral of a net force resulting from the generated driving force and the substantially constant frictional force over the first interval divided by the magnitude of the substantially constant frictional force, the first part essentially comes to a standstill at the end of each period.

In an embodiment, the pulsed driving current has a waveform in the shape of a periodic pulse train, wherein, within each period, a first current pulse is applied over a first sub-interval and a second current pulse in an opposite direction is applied over a second sub-interval, subsequent to the first sub-interval.

This decreases the required amount of friction for a given duration of a period of the periodic pulse train, since the first part is broken before the end of each period by the second current pulse as well. At a given amount of friction, the frequency of the periodic pulse train can be increased, allowing faster control of the position of the first part.

According to another aspect, the apparatus for driving an actuator assembly according to the invention is configured to execute a method according to the invention.

According to another aspect of the invention, there is provided an opto-mechanical device comprising an actuator assembly according to the invention and/or an apparatus according to the invention.

The invention will now be exemplarily explained in further detail with reference to the accompanying drawings, in which:

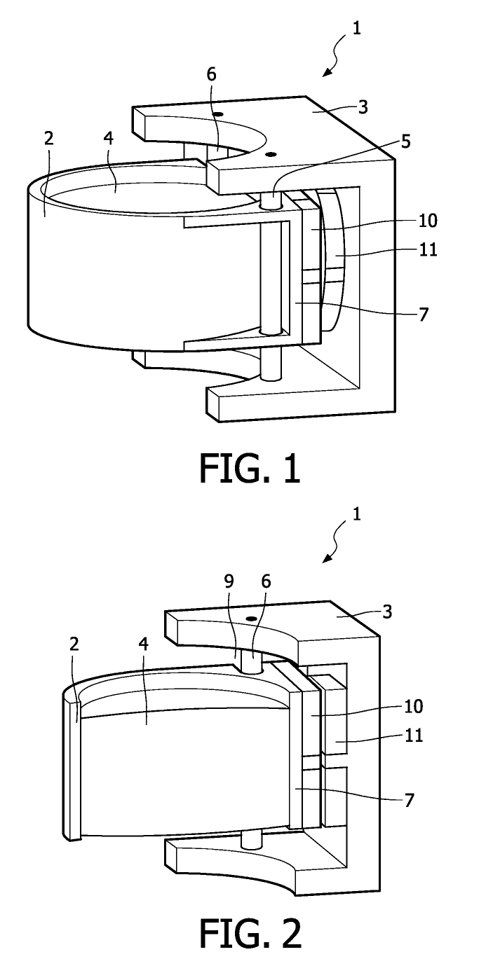

FIG. 1 is a perspective view of a first embodiment of an actuator assembly;

FIG. 2 is a perspective cross-sectional view of the actuator assembly of FIG. 1;

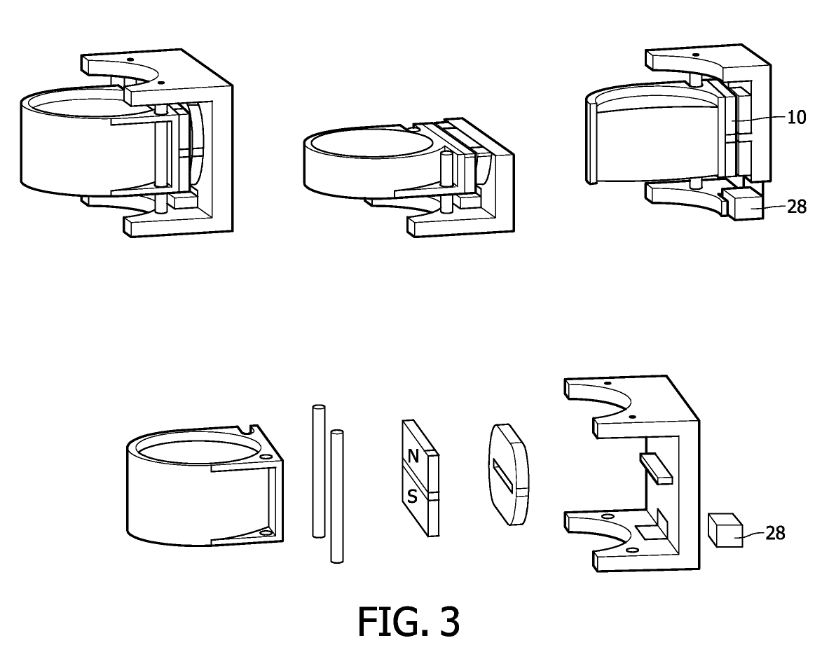

FIG. 3 shows the placement of a Hall sensor 28 as position detector close to the magnet 10 for measuring the movement of the actuator;

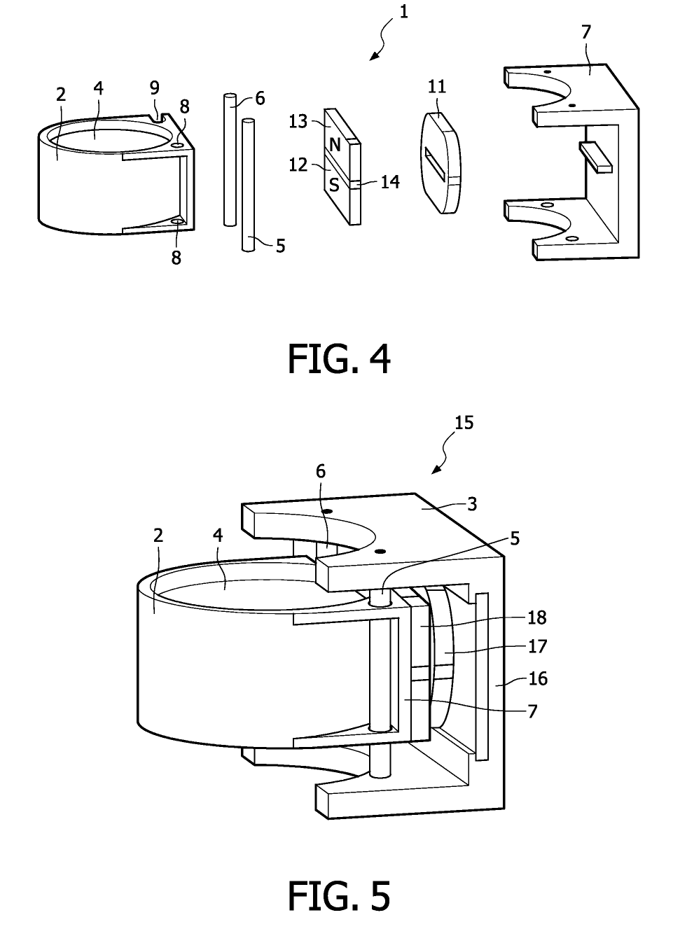

FIG. 4 is an exploded view of the actuator assembly shown in FIG. 1;

FIG. 5 is a perspective view of a second embodiment of an actuator assembly;

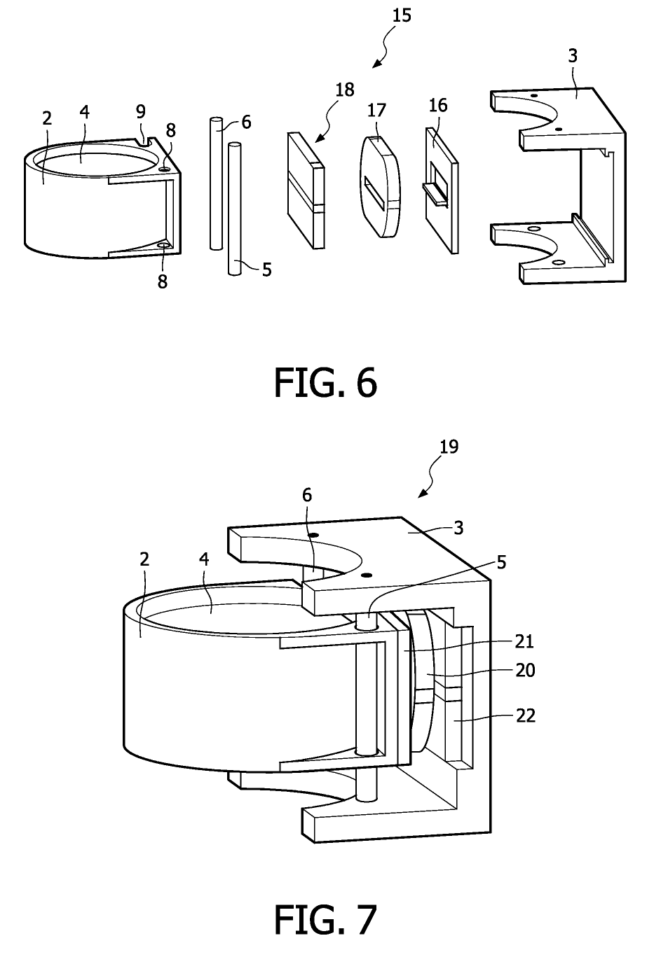

FIG. 6 is an exploded view of the actuator assembly shown in FIG. 5;

FIG. 7 is a perspective view of a third embodiment of an actuator assembly;

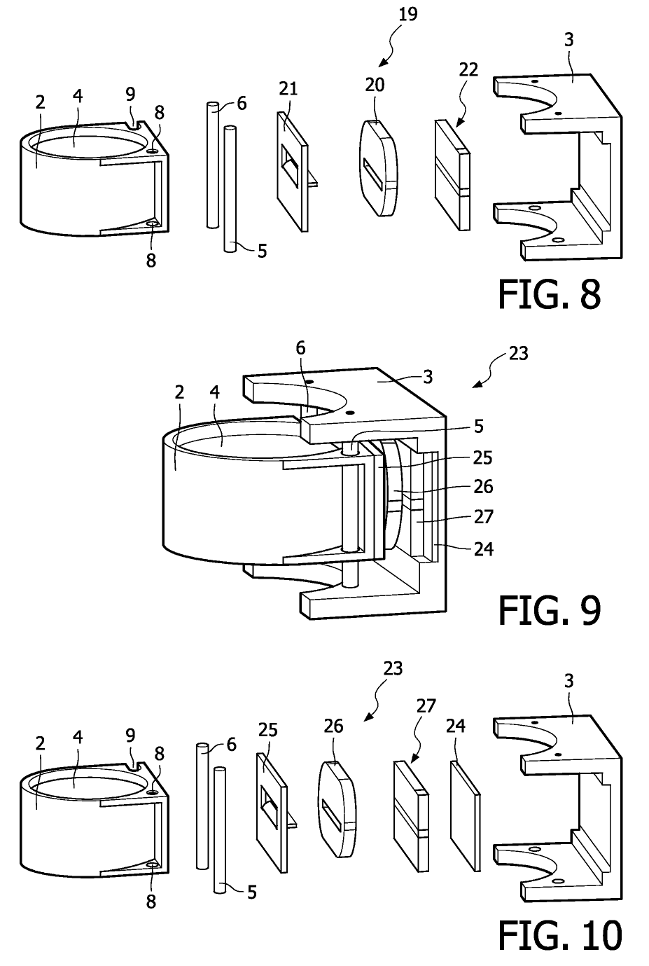

FIG. 8 is an exploded view of the actuator assembly shown in FIG. 7;

FIG. 9 is a perspective view of a fourth embodiment of an actuator assembly;

FIG. 10 is an exploded view of the actuator assembly shown in FIG. 9;

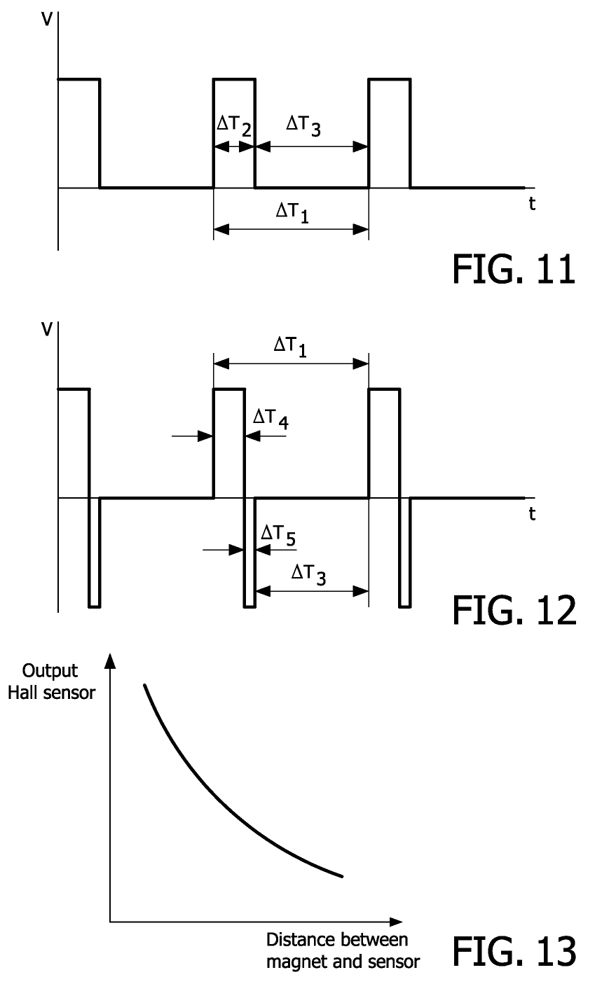

FIG. 11 is a diagram containing a graph of the voltage applied to a coil in an actuator assembly in a first method of driving the actuator assembly;

FIG. 12 is a diagram containing a graph of the voltage applied to the coil in a second method of driving the actuator assembly;

FIG. 13 shows a diagram of the output signal (voltage or current) of a Hall sensor as a function of the distance between a magnet and the Hall sensor;

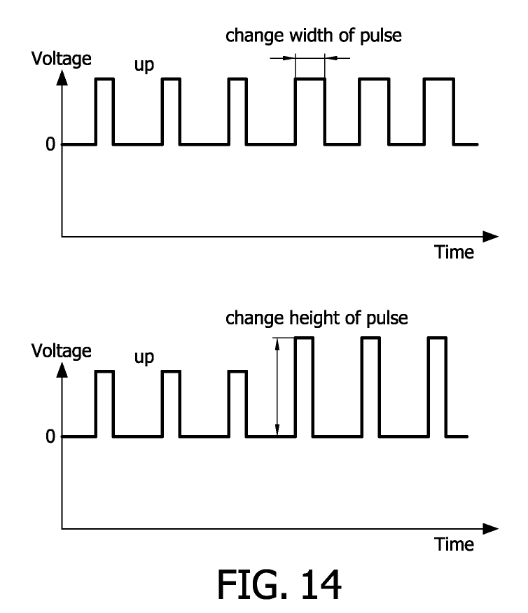

FIG. 14 shows diagrams of the voltage in the Hall sensor in which the width (upper Figure) or the height (lower Figure) is adapted as a function of time;

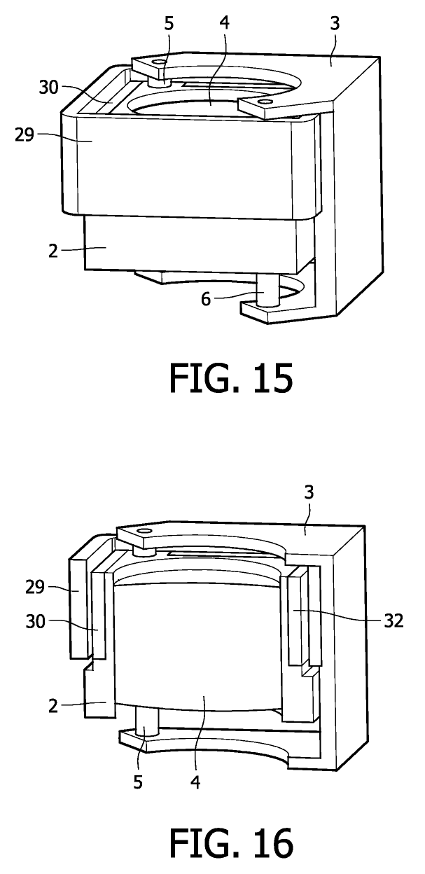

FIG. 15 is a perspective view of a fifth embodiment of an actuator assembly;

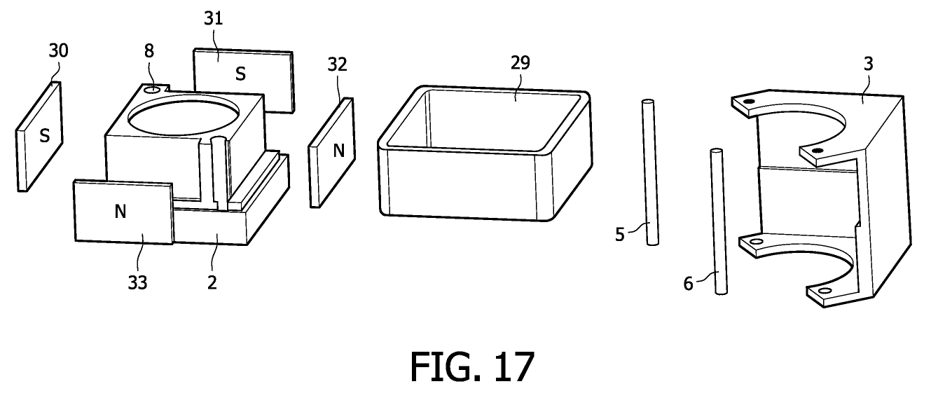

FIG. 16 is a perspective cross-sectional view of the actuator assembly of FIG. 15;

FIG. 17 is an exploded view of the actuator assembly shown in FIG. 15;

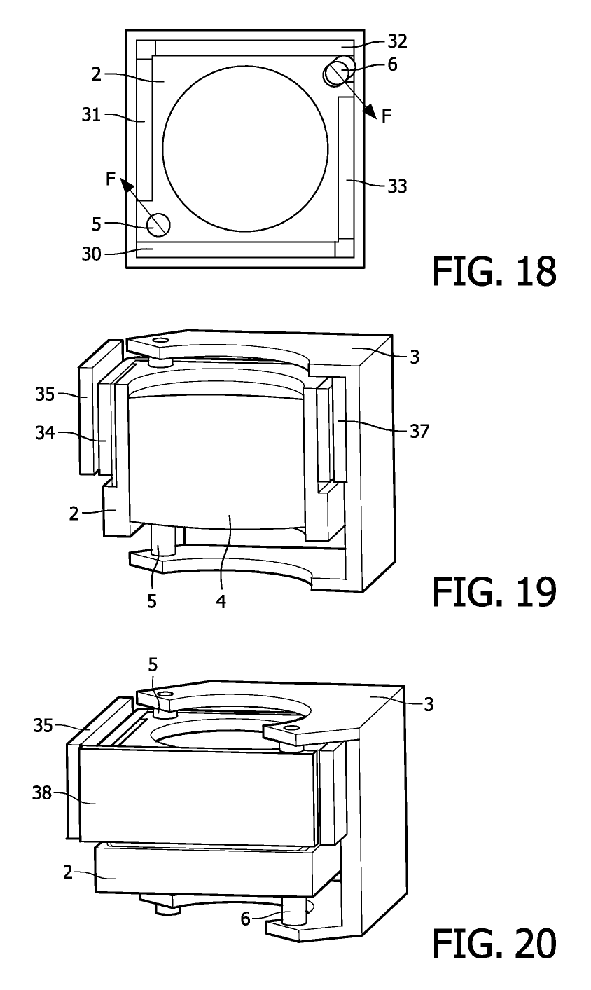

FIG. 18 shows forces F acting on the guidance pins 5 and 6;

FIG. 19-21 show a sixth actuator assembly;

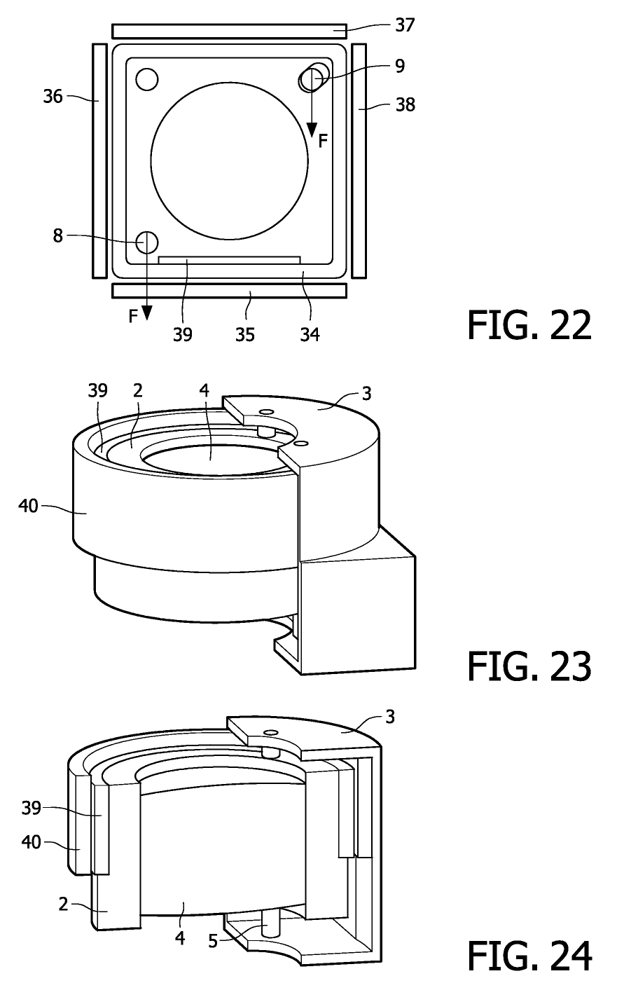

FIG. 22 shows forces F acting on the guidance pins 5 and 6;

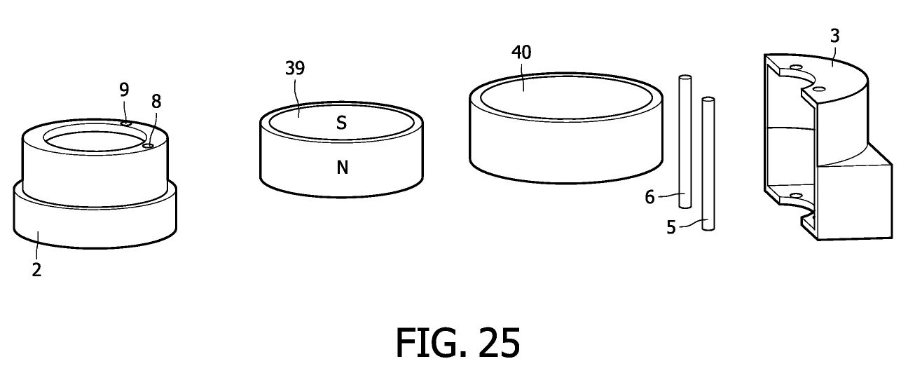

FIG. 23-25 show a seventh actuator assembly;

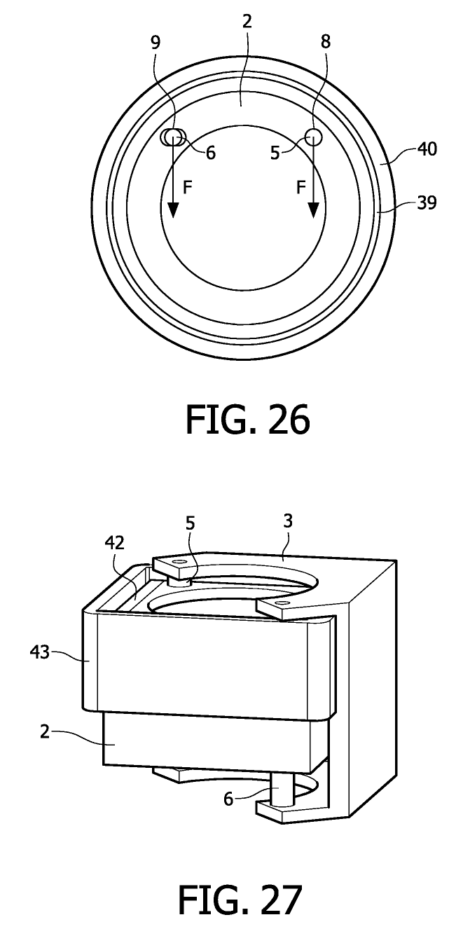

FIG. 26 shows forces F acting on the guidance pins 5 and 6;

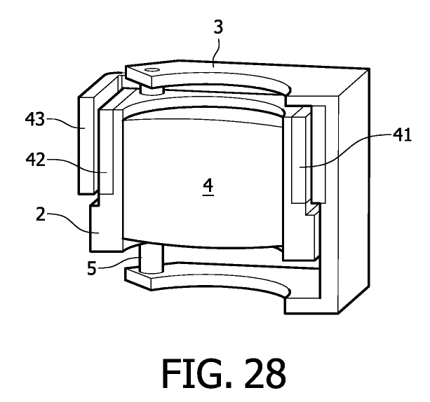

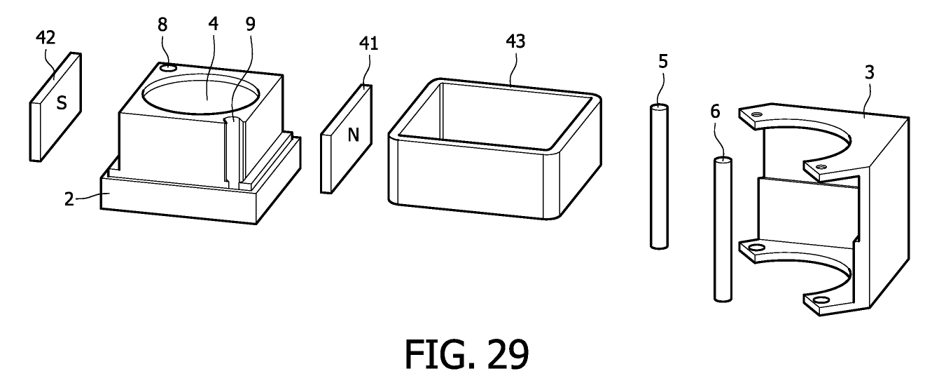

FIG. 27-29 show an eighth actuator assembly; and

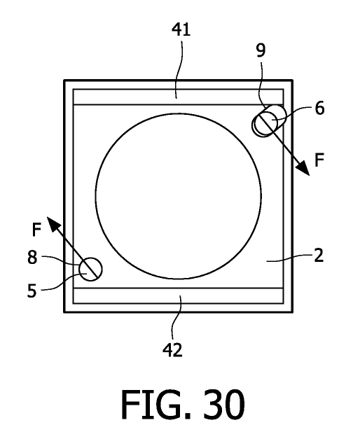

FIG. 30 shows forces F acting on the guidance pins 5 and 6

Implementations of actuator assemblies in opto-mechanical products will be explained below as an example. The description will focus on the field of imaging optics for small applications, such as web cameras, including those integrated in Liquid Crystal Display (LCD) flat panel displays, for mobile phones, Personal Digital Assistants (PDAs), etc. In camera's, for instance, the actuator assembly can be used for autofocus movement, optical zoom, mechanical shutter actuation, diaphragm opening control, compensation of tilt between optics and imager, x-y movement of an image sensor to compensate for camera shake, etc. More generally the actuator assembly finds application in any field in which an actuator assembly allowing small displacements and requiring low forces to hold the movable parts in position is useful. This includes the field of magnetic and/or optical recording, for example. It also includes applications in toys, such as remotely controlled model cars and planes, game controllers with tactile feedback, etc. Another field of application is that of industrial and/or automotive equipment, e.g. to operate proportional valves for fluids and gasses, mass flow controllers, etc. Yet another field of application is in lighting, to focus small bundles of light, for example by moving a lens in front of a bright Light Emitting Diode (LED). The assembly and method of driving it are particularly suited to mobile applications, where low power consumption is an issue.

In FIGS. 1, 2 and 4 a first actuator assembly 1 includes a first part and a second part, in this example formed as a barrel 2 and a housing 3, respectively. The barrel 2 is movable with respect to the housing 3. In the example (see FIG. 2), the barrel 2 carries a lens body 4. The barrel 2 carries a lens assembly comprising more than one lens in other embodiments.

The barrel 2 is linearly guided to allow focusing of an optical system comprising the lens body 4. To this end, the housing includes a guide, in this example in the form of two guidance pins 5,6. The barrel 2 includes holes 8 and recesses 9 through which the guidance pins 5,6 travel. The guidance pins 5,6 are just an example of a mechanical guide. In other embodiments of the actuator assembly, the housing comprises at least one rail and the movable part of the assembly comprises at least one traveler co-operating with one of the rails to guide the motion of one part of the actuator assembly relative to another part. In other embodiments, the part of the actuator assembly carrying a lens assembly is provided with the guide, and the guide co-operates with a frame of a stationary part of the opto-mechanical device.

A permanent magnet 10 is attached to the barrel 2. The permanent magnet 10 establishes a field of force acting on the guidance pins 5,6, which are made of a ferromagnetic material. In another embodiment, a mechanical resilient means is used to press a brake shoe against the guidance pins 5,6. However, the use of a means for establishing a field of force has the advantage of requiring fewer components, as well as allowing relatively unconstrained movement of the barrel 2.

The force provided by the permanent magnet 10 and acting on the guidance pins 5,6 is in a direction transverse to the guide, perpendicular to the direction of movement of the barrel 2 relative to the housing 3. Due to this force, inside surface parts of the holes 8 and recesses 9 are forced against the surface of the guidance pins 5,6. As a result, movement of the barrel along the guide 5,6 is opposed by a substantially constant frictional force. The frictional force remains constant within a margin defined by fluctuations of the coefficient of friction due to changing environmental conditions, such as humidity, temperature, etc. Because the inside surface parts of the holes 8 and recesses 9 are forced against the surface of the guidance pins, wear of the barrel 2 will have relatively little effect on the frictional force. Another added advantage is that the transverse force removes play in the position of the barrel 2. This is an advantage in opto-mechanical devices, in which the optical axis of the lens body 4 needs to be aligned with respect to other optical components.

It is observed that the holding force may be varied by varying the distance of the holes 8 and recesses 9 to the guidance pins 5,6. A higher holding force results in a higher static frictional force (when the barrel 2 is stationary relative to the housing 3), which may be desirable in applications in which the first actuator assembly is subjected to shocks (e.g. Optical Pick-up Units in Optical recording apparatuses). An embodiment such as that of FIGS. 1, 2 and 4, in which the permanent magnet 10 exerts a force on ferromagnetic guidance pins 5,6 has the advantage of comprising few parts.

To displace the barrel 2 in the direction determined by the guidance pins 5,6, the first actuator assembly 1 includes an electrically conductive coil 11, with terminals (not shown) for applying a driving voltage. The electrically conductive coil 11 is attached to the housing 3 in this embodiment. This allows relatively large displacements of the barrel 2, since there are no wires to the barrel. Current passing through the electrically conductive coil 11 gives rise to a magnetic field acting on the permanent magnet 10.

The permanent magnet 10 shown in FIG. 4 includes two opposite end zones 12,13, separated by a transition zone 14. The three zones lie in a line substantially parallel to the direction of motion of the barrel 2. A first end zone 12 has a magnetization in a direction away from the guidance pins 5,6. A second end zone 13 has a magnetization in the opposite direction, i.e. towards the guidance pins 5,6. The effect is that the permanent magnet 10 produces flux lines perpendicular to its face and to the longitudinal axes of the guidance pins 5,6, and also provides opposite north and south poles in the direction parallel to the guidance pins 5,6. These opposite poles are required for driving the barrel 2, because the electrically conductive coil 11 has windings centered on an axis perpendicular to the guidance pins 5,6. The construction of the permanent magnet 10 allows the above-mentioned effect to be achieved without the use of a yoke. The overall configuration is relatively compact, as well as reducing the number of parts of the first actuator assembly.

FIGS. 5 and 6 show a second actuator assembly 15. Like parts are numbered in the same way as in FIGS. 1, 2 and 4. In addition to, or instead of, ferromagnetic guidance pins 5,6, the second actuator assembly 15 includes a ferromagnetic back plate 16. The second actuator assembly 16 further includes a stationary electrically conductive coil 17, and a barrel-mounted permanent magnet 18. The barrel-mounted permanent magnet 18 is similar in construction to the permanent magnet 10 of the first actuator assembly 1. The electrically conductive coil 17 is arranged in between the barrel-mounted permanent magnet 18 and the ferromagnetic back plate 16. The latter acts to enhance the magnetic field generated when current is passed through the electrically conductive coil 17. In addition, the ferromagnetic back plate 16 interacts with the permanent magnet 18 to provide the force holding the inside surface parts of the holes 8 and recesses 9 against the guidance pins 5,6.

It is noted that, compared to the embodiment of FIGS. 1, 2 and 4, flexibility of design is lost to a certain extent. For a given motor configuration, the force transverse to the guidance pins 5,6 is fixed, whereas, in the embodiment of FIGS. 1, 2 and 4, it can be determined independently by varying the position of the holes 8 and recesses 9 to vary the distance between the permanent magnet 10 and (ferromagnetic) guidance pins 5,6. On the other hand, a relatively large ferromagnetic back plate 16, allows for use of a smaller barrel-mounted permanent magnet 18. Moreover, variation of the dimensions of the electrically conductive coil 17 still allows one to change the distance between the barrel-mounted permanent magnet 18 and the ferromagnetic back plate 16.

FIGS. 7 and 8 depict a third actuator assembly 19. The third actuator assembly 19 includes a barrel-mounted electrically conductive coil 20, positioned in between a barrel-mounted ferromagnetic back plate 21 and a stationary permanent magnet 22. The stationary permanent magnet 22 is attached to the housing 3, and of a similar construction to the permanent magnet 10 included in the first actuator assembly 1. The configuration of the third actuator assembly 19 allows for a relatively large stationary permanent magnet 22 to be used.

FIGS. 9 and 10 depict a fourth actuator assembly 23. In this embodiment, a first ferromagnetic back plate 24 is attached to the housing 3. The barrel 2 includes a second ferromagnetic back plate 25 and a barrel-mounted electrically conductive coil 26. A stationary permanent magnet 27 is mounted to the housing 3, so as to be positioned between the first ferromagnetic back plate 24 and the barrel-mounted electrically conductive coil 26. The stationary permanent magnet 27 is of the same construction as the permanent magnet 10 described above with reference to FIGS. 1, 2 and 4. An embodiment in which the positions of the barrel-mounted electrically conductive coil 26 and the stationary permanent magnet 27 are interchanged is conceivable. The first and second ferromagnetic back plates 24,25 enhance the magnetic fields provided by the stationary permanent magnet 27 and barrel-mounted electrically conductive coil 26. Thus, faster positioning and/or lower electrical power consumption are made possible. In other embodiments, the barrel-mounted electrically conductive coil 26 can have smaller dimensions, decreasing its mass.

The first, second, third and fourth actuator assembly 1,15,19 and 23 can be driven in substantially the same way. Each is provided with means for providing a force transverse to the guidance pins 5,6, acting to hold inside surface parts of the holes 8 and recesses 9 against the surface of the guidance pins 5,6. Thus, static friction prevents motion of the barrel 2 relative to the housing 3 when no current is passed through the electrically conductive coils 11,17,20,26. This enables the barrel 2 to be displaced relative to the housing 3 using a pulsed current, which reverts to a low level or no current at all between pulses. Friction ensures that the position occupied by the barrel is maintained. With a substantially constant, and thus predictable, friction force opposing motion of the barrel 2, open-loop control becomes possible. This simplifies the driver construction, compared with stepper motors, piezo drives and voice coil actuators in a servo system.

FIGS. 11 and 12 show the voltage applied to terminals of the electrically conductive coils 11,17,20,26 in two different modes of driving. In each, a driver apparatus translates a desired displacement into a series of substantially equal incremental displacements. Each displacement is effected by applying a periodic pulse train for a number of periods corresponding to the number of incremental displacements. The driver apparatus need only be configured to store the distance corresponding to the incremental displacement, together with the waveform of the current required to effect the incremental displacement. It is not necessary to have the driver include memory for storing a parameter field.

It will be appreciated that the direction of movement of the first part relative to the second part is changed by changing the polarity of the periodic pulse train that is applied.

In FIGS. 11 and 12, ΔT₁ indicates the duration of one period of the waveform characterizing the periodic pulse train. In FIG. 12, a pulse is applied over a first interval ΔT₂. In the illustrated embodiment, no current is passed through the electrically conductive coils 11,17,20,26 during a second interval ΔT₃. This allows the barrel 2 essentially to come to a standstill before the next incremental displacement is effected by applying a further pulse. Instead of applying no current at all during the second interval ΔT₃, a current smaller than that required to generate a sufficiently large driving force to overcome the frictional resistance may be passed through the electrically conductive coils 11,17,20,26. If the magnitude of the frictional force during motion of the barrel 2 is denoted by F_{f}, and that of the driving force generated by the permanent magnets 10,18,22 and electrically conductive coils 11,17,20,26 is denoted as F_{d}, then the net force acting on the barrel 2 during the first interval is F_{d}−F_{f}. The length of the second interval ΔT₃ is given by the following equation:

$$Δ {T}_{3} \geq \frac{{\int }_{Δ {T}_{2}} {F}_{d} - {F}_{f} d t}{{F}_{f}} .$$

It is observed that both FIGS. 11 and 12 relate to embodiments in which voltage pulses of substantially equal amplitude are applied. This is an advantage in simple mobile applications where only one system voltage is available. In more sophisticated embodiments, the pulse height and/or duration are modulated.

The embodiment shown in FIG. 12 has the advantage that the period ΔT₁ of the waveform is shorter, because the second interval ΔT₃ required to brake the barrel is shorter. This is due to the fact that each period ΔT₁ commences with a first sub-interval ΔT₄ in which a first pulse is applied, with a second pulse being applied over a second sub-interval ΔT₅, during which a second pulse of opposite polarity is applied. The second pulse serves to enhance the braking force due to friction.

The amount of friction depends partly on the choice of material for the barrel 2 and guidance pins 5,6. In one example, the barrel 2 is made of a liquid crystal polymer, which is wear-resistant and amenable to accurate machining. The guidance pins 5,6 can be made of steel with extra polishing being applied, if required. Sapphire bearings in the barrel 2 may be employed in high-end applications.

The displacement of the first part in respect to the second part can be measured by a position measuring sensor. Different types of sensors can be used. These include optical reflector types and magnetic field sensor types for example.

In an embodiment of the actuator one or more magnets are present. Measurement of the displacement can be made between a first part with a magnet and a second part equipped with a hall sensor.

FIG. 3 shows an embodiment comprising a hall sensor 28 and a moving magnet 10. The movement is detected by the hall sensor located near the magnet. The magnet generates a voltage in the hall sensor which is a function of the relative distance between sensor and magnet. FIG. 13 shows an example of such a function.

After a step, it is possible to determine the distance of the actual travel using a position-measuring sensor (e.g. a hall sensor). If the distance shows a deviation from the intended step, the width or height of the voltage pulse can be adapted to correct the distance of a next step. See FIG. 14.

Other embodiments can contain multiple magnets or differently shaped magnets. As example some embodiments with two magnets, four magnets and a cylindrical magnet are shown.

FIGS. 15-17 show a fifth actuator assembly. Like parts are numbered in the same way as in FIGS. 1, 2 and 4. In addition, or instead of, the fifth actuator assembly includes four permanent magnets 30-33 and a stationary electrically conductive coil 29. The four permanent magnets 30-33 are arranged around the barrel 2 and fixed to it. The coil 29 is static and attached to the housing 3. A small gap separates the magnets and coil.

The size of the permanent single magnet 31 is, preferably, about the same as the size of magnet 33. Preferably magnets 31 and 33 have equal constructions. All magnets have the same magnetisation direction in respect to the coil side closest to them. In FIG. 17 all magnets 30-33 have their South magnetisation direction S facing the centre of the barrel and their North magnetisation direction N facing away from the barrel.

The barrel 2 is linearly guided to allow focussing of an optical system comprising the lens body 4. To this end, the housing includes two guidance pins 5,6. The barrel 2 includes holes 8 and recesses 9 through which the guidance pins 5,6 travel.

The permanent magnets 30-33, attached to the barrel, establishes a field of force acting on the guidance pins 5,6, which are made of a ferromagnetic material. The resulting forces provided by the permanent magnets 30-33 and acting on the guidance pins 5,6 is in a direction transverse to the guide, perpendicular to the direction of movement of the barrel 2 relative to the housing 3. Due to this force, inside surface parts of the holes 8 and recesses 9 are forced against the surface of the guidance pins 5,6. As a result, movement of the barrel along the guides 5,6 is opposed by a frictional force.

FIG. 18 shows the resulting forces F. The resulting forces F are symmetrical around the centre of mass of the barrel 2, resulting in very little tilt of the barrel 2 versus the housing 3 and little noise during movement.

FIGS. 19-21 show a sixth actuator assembly. Like parts are numbered in the same way as in FIGS. 1, 2 and 4. In addition, or instead of, the fifth actuator assembly includes four permanent stationary magnets 35-38 and an electrically conductive coil 34. The coil 34 is arranged around the barrel 2 and fixed to it. The four permanent magnets 35-38 are static and attached to the housing 3. The sixth actuator assembly further includes a ferromagnetic plate 39 fixed to the barrel. A small gap separates the magnets and coil.

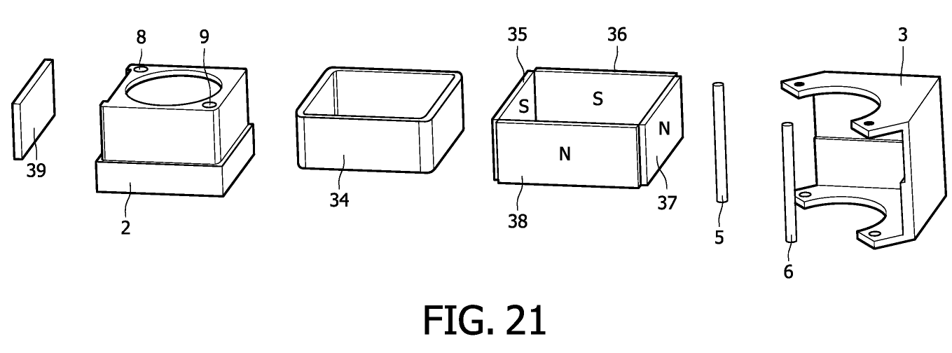

All magnets have the same magnetisation direction in respect to the coil side closest to them. In FIG. 21 all magnets 30-33 have their South magnetisation direction S facing the centre of the barrel and their North magnetisation direction N facing away from the barrel. The guidance pins 5,6 are made of a non-ferromagnetic material.

The permanent magnets 35-38, attached to the housing, establishes a field of force acting on the ferromagnetic plate 39 attached to the barrel.

The resulting forces provided by the permanent magnets 35-38 and acting on the plate 39 is in a direction transverse to the guide, perpendicular to the direction of movement of the barrel 2 relative to the housing 3. Due to this force, inside surface parts of the holes 8 and recesses 9 are forced against the surface of the guidance pins 5,6. As a result, movement of the barrel along the guides 5,6 is opposed by a frictional force.

FIG. 22 shows the resulting forces F.

FIGS. 23-25 show a seventh actuator assembly. Like parts are numbered in the same way as in FIGS. 1, 2 and 4. In addition, or instead of, the seventh actuator assembly includes one cylindrical permanent magnet and a stationary electrically conductive coil 40. The magnet 39 is arranged around the barrel 2 and fixed to it. The coil 40 is static and attached to the housing 3. A small gap separates the magnets and coil.

The magnet 39 has a radial magnetisation direction. In FIG. 25 the magnet 39 has a South magnetisation direction S facing the centre of the barrel and a North magnetisation direction N facing away from the barrel.

The barrel 2 is linearly guided to allow focussing of an optical system comprising the lens body 4. To this end, the housing includes two guidance pins 5,6. The barrel 2 includes holes 8 and recesses 9 through which the guidance pins 5,6 travel.

The permanent magnets 39, attached to the barrel, establishes a field of force acting on the guidance pins 5,6, which are made of a ferromagnetic material. The resulting forces provided by the permanent magnet 39 and acting on the guidance pins 5,6 is in a direction transverse to the guide, perpendicular to the direction of movement of the barrel 2 relative to the housing 3. Due to this force, inside surface parts of the holes 8 and recesses 9 are forced against the surface of the guidance pins 5,6. As a result, movement of the barrel along the guides 5,6 is opposed by a frictional force.

FIG. 26 shows the resulting forces F.

FIGS. 27-29 show an eighth actuator assembly. Like parts are numbered in the same way as in FIGS. 1, 2 and 4. In addition, or instead of, the eighth actuator assembly includes 2 permanent magnets 41-42 and a stationary electrically conductive coil 43. The two permanent magnets 41-42 are arranged along the barrel 2 and fixed to it. The coil 43 is static and attached to the housing 3. A small gap separates the magnets and coil.

The permanent single magnet 41 is equal in size to magnet 42. All magnets have the same magnetisation direction in respect to the coil side closest to them. In FIG. 29 all magnets 41-42 have their South magnetisation direction S facing the centre of the barrel and their North magnetisation direction N facing away from the barrel.

The barrel 2 is linearly guided to allow focussing of an optical system comprising the lens body 4. To this end, the housing includes two guidance pins 5,6. The barrel 2 includes holes 8 and recesses 9 through which the guidance pins 5,6 travel.

The permanent magnets 41-42, attached to the barrel, establishes a field of force acting on the guidance pins 5,6, which are made of a ferromagnetic material. The resulting forces provided by the permanent magnets 41-42 and acting on the guidance pins 5,6 is in a direction transverse to the guide, perpendicular to the direction of movement of the barrel 2 relative to the housing 3. Due to this force, inside surface parts of the holes 8 and recesses 9 are forced against the surface of the guidance pins 5,6. As a result, movement of the barrel along the guides 5,6 is opposed by a frictional force.

FIG. 30 shows the resulting forces F. The resulting forces F are symmetrical around the centre of mass of the barrel 2, resulting in very little tilt of the barrel 2 versus the housing 3 and little noise during movement.

In the fifth to the eighth actuator assemblies, magnets and coil are placed in symmetry around the middle of the barrel 2. This symmetry results in a resulting Lorentz force acting on the middle of the barrel 2. The centre of the moving mass coincides or lies very close to the middle of the barrel 2. The resulting Lorentz force acting in the same point as the centre of moving mass, results in a smooth running of the actuator with the advantageous effects of less tilt of the actuator and less noise production.

It should be noted that the above-mentioned embodiments illustrate, rather than limit, the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

The guide on the surface of which friction is generated may be any bar, rod, or other mechanical construct directing the motion of one part of the actuator assembly relative to the other. In an alternative embodiment, the force acting to hold at least one surface part of a first part against a surface of the guide is generated by a pair of permanent magnets, a first one attached to the first part, a second one attached to the part with respect to which the first part is displaced.

1-12. (canceled)

13. Actuator assembly, including
a first part (2),
a second part (3), the second part (3) including a guide (5,6) for guiding motion of the first part (2) relative to the second part (3), and
means (10,11; 16-18; 20-22; 24-27) for generating a driving force between the first part (2) and the second part (3) along the guide(s) (5,6) in response to a driving current, and
means (5,6,10; 16,18; 21,22; 24,25,27) for providing a force transverse to the guide (5,6), acting to hold at least one surface part of the first part against a surface of the guide (5,6), wherein at least one permanent magnet (10, 18, 22, 27) is comprised in both the means for generating a driving force and the means for providing the force transverse to the guide.

14. Actuator assembly according to claim 13, wherein the means for providing a force transverse to the guide include at least one means (10;18;22;27) for establishing a field of force, attached to one of the first and second parts and acting on at least a component (5,6; 16; 21; 25) of the other of the first and second parts.

15. Actuator assembly according to claim 13, wherein the means for generating a driving force include at least one electrically conductive coil (11; 17; 20; 26), attached to the other of the first and second parts, for generating a magnetic field acting on the at least one permanent magnet (10; 18; 21; 27), in response to the driving current.

16. Actuator assembly according to claim 15, wherein the other of the first and second parts further includes a ferromagnetic back plate (16; 21; 25), wherein the electrically conductive coil (17;20; 26) is positioned between the ferromagnetic back plate (16; 21; 25) and at least one of the permanent magnets (18; 22; 27).

17. Actuator assembly according to claim 15, wherein the second part (3) includes a ferromagnetic back plate (16; 24), wherein one of the electrically conductive coil (17) and the at least one permanent magnet (27) is positioned between the ferromagnetic back plate (16; 24) and the other of the electrically conductive coil (25) and the at least one permanent magnet (18).

18. Actuator assembly according to claim 15, wherein the at least one permanent magnet (10; 18; 22; 27) includes two magnetized zones (12,13), positioned in a line, wherein respective components of magnetization perpendicular to the line are oriented in opposite directions.

19. Method of driving an actuator assembly (1; 15; 19; 23),
the actuator assembly including a first part (2), a second part (3), the first part (2) being movable relative to the second part (3), and means (10,11; 16-18; 20-22; 24-27) for generating a driving force between the first part and the second part in response to a driving current, wherein the first part comprises at least one permanent magnet (10, 18, 22, 27) and is displaced in opposition to a substantially constant frictional force from a first position to a second position,
which method comprises the step of applying a pulsed driving current to the means (10,11;16-18;20-22; 24-27) for generating a driving force, pre-determined to result in a total displacement substantially equal to the distance between the first and the second position.

20. Method according to claim 19, wherein the pulsed driving current has a waveform in the shape of a periodic pulse train, wherein each period includes a first interval (ΔT₂;ΔT₄+ΔT₅) during at least part of which a current is applied, followed by a second interval (ΔT₃) during which the magnitude of any current applied is lower than a current level for generating a driving force sufficient to overcome the substantially constant frictional force, wherein the length of the second interval (ΔT₃) equals at least the integral of a net force resulting from the generated driving force and the substantially constant frictional force over the first interval divided by the magnitude of the substantially constant frictional force.

21. Method according to claim 19, wherein the pulsed driving current has a waveform in the shape of a periodic pulse train, wherein, within each period, a first current pulse is applied over a first sub-interval (ΔT₄) and a second current pulse in an opposite direction is applied over a second sub-interval (ΔT₅), subsequent to the first sub-interval (ΔT₄).

22. Apparatus for driving an actuator assembly (1; 15; 19; 23),
the actuator assembly including a first part (2), a second part (3), the first part being movable relative to the second part, and means (10,11; 16-18; 20-22; 24-27) for generating a driving force between the first part and the second part in response to a driving current, wherein the first part comprises at least one permanent magnet (10, 18, 22, 27) and is displaced in opposition to a substantially constant frictional force from a first position to a second position,
which apparatus comprises an apparatus for applying a driving current to the means for generating a driving force, wherein the apparatus is configured to execute a method according to claim 19.

23. Opto-mechanical device comprising an actuator assembly according to claim 13.
